(19) United States
(12) Patent Application Publication
(10) Pub. No.: US 2011/0014826 A1
(43) Pub. Date: Jan. 20, 2011

(54) Lead pin for package substrate

(75) Inventors: Ki Taek Lee, Seoul (KR); Heung Jae Oh, Suwon-si (KR); Sung Won Jeong, Yongin-si (KR); Jin Won Choi, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/805,211

(22) Filed: Jul. 19, 2010

(30) Foreign Application Priority Data
Jul. 20, 2009 (KR) 10-2009-0066091
Dec. 14, 2009 (KR) 10-2009-0123932
Feb. 16, 2010 (KR) 10-2010-0013811

(51) Int. Cl. H01R 13/04

(52) U.S. Cl. 439/884

(57) ABSTRACT

Disclosed herein is a lead pin for a package substrate. The lead pin for the package substrate that is bonded to a package substrate by interposing a solder paste between the lead pin for the package substrate and the package substrate, the lead pin for the package substrate including: a cylindrical connection pin; and a head part that is formed on one end of the connection pin, wherein the head part includes a disk shaped flange part, and a round part that is formed on one surface of the flange part and is configured to include first and second curved surfaces having different radii of curvature, the first and second curved surfaces each having different radii of curvature selected from a range of 1:0.1 to 1:5 as compared to a diameter of the connection pin.

### CROSS REFERENCE TO RELATED APPLICATION

This application claims the benefit of Korean Patent Application No. 10-2009-0066091, filed on Jul. 20, 2010, entitled “Lead Pin For Package Substrate”, which is hereby incorporated by reference in its entirety into this application.

### BACKGROUND OF THE INVENTION

1. Technical Field

The present invention relates to a lead pin for a package substrate, and more particularly, to a lead pin for a package substrate to improve bonding efficiency for the package substrate and to prevent pollution by a solder paste.

2. Description of the Related Art

With the development of the electronics industry, various types of semiconductor packages have been manufactured. Recently, a package substrate in a Pin Grid Array (PGA) type in which a plurality of T-type lead pins are mounted has been widely used as a substrate that connects a package substrate on which an integrated circuit (IC) is mounted to a main board.

In a general package substrate, a lead pin insert type in which a lead pin is inserted through a hole and a T-type lead pin that is attached to a package substrate by a soldering have been mainly used. However, the T-type lead pin has gradually become widespread due to a limitation of the available area for the circuit configuration of the package substrate as compared to the lead pin insert type.

However, the T-type lead pin has disadvantages in that the lead pin is inclined and it is difficult to maintain uniform bonding strength. In particular, as the use of lead has been recently limited in consideration of environmental effects due to soldering, a solder (Sn—Ag—Cu, and Sn—Sb) not using lead has been used, such that the melting temperature of the solder is increased. At this time, as the melting temperature of the soldering is high, solder for connecting lead pins that support lead pins is melted by reflow heat during a reflow process for mounting an IC chip on a package substrate, thereby causing an inclination of the lead pins. For example, several hundreds of lead pins mounted on a semiconductor are used in a CPU package substrate. Therefore, if any one of the lead pins is inclined, the CPU itself cannot be mounted on a socket, such that the package substrate itself is regarded as a defective product.

Further, there is a possibility that voids are formed between the head part of the lead pin and a solder when soldering the T-type lead pin according to the related art. Problems according to the related art will be described with reference to the accompanying drawings.

FIG. 1 is a diagram showing one example of a configuration in which a lead pin is bonded to a package substrate according to the related art, and a FIG. 2 is a diagram showing another example of a configuration in which a lead pin is bonded to a package substrate according to the related art.

Referring to FIGS. 1 and 2, after a solder paste 12 is applied to a pad part 11 of a package substrate 10, a lead pin 20 is mounted on the pad part 11 of the package substrate 10 so that the head part 21 of the lead pin 20 contacts the pad part 11 thereof. In a state where the plurality of lead pins 20 are mounted on the pad part 11 of the package substrate 10, a reflow process of mounting an IC chip on the package substrate 10 is performed. Thereby, a structure of the package substrate 10 in which the IC chip is mounted and the lead pins 20 are bonded is provided.

However, in case where the solder paste 12 is applied as described above, when voids 13 are generated within the solder paste 12, bonding strength of the lead pins 20 may be degraded and the lead pin may be inclined to one side thereof as shown in FIG. 2.

In addition, the solder paste (Sn95-Sb5, melting point 232 to 240° C.) for coupling the lead pins 20 has a higher melting point as compared to the solder paste (Sn96-Ag3.5-X solder, melting point 221° C.) for coupling the IC chips. However, in order to minimize thermal impact that is applied to the package substrate 10 during the reflow process, the heating time at the temperature of the melting point or more is controlled to be short, such that there is insufficient time to remove the voids 13 in the soldering. As a result, the melted surface of the solder paste 12 itself does not become uniform or tension with the lead pins 20 is generated due to the expansion of the voids 13, such that a bonding defect is caused due to the inclination of the lead pin 20 to one side.

Also, during the reflow process, some of the solder paste 12 are melted to bulge along the head part 21 of the lead pin 20 to be bonded to the connection pin of the lead pin 20. In this case, when the lead pin 20 is mounted on the socket, the solder paste 12 directly contacts the pad of the socket, thereby causing a short defect.

### SUMMARY OF THE INVENTION

An object of the present invention is to provide a lead pin that prevents the lead pin from being polluted by a solder paste and to prevent an electrical short defect.

Another object of the present invention is to provide a lead pin that improves a bonding efficiency of the lead pin by increasing a bonding area of the lead pin with respect to a package substrate.

Still another object of the present invention is to provide a lead pin for a package substrate that prevents the connection pin from being polluted and to improve a bonding efficiency of the lead pin by increasing a contact area of a head part and a solder paste.

### BRIEF DESCRIPTION OF THE DRAWINGS

FIG. 1 is a diagram showing one example of a configuration in which a lead pin is bonded to a package substrate according to the related art;

FIG. 2 is a diagram showing another example of a configuration in which a lead pin is bonded to a package substrate according to the related art;

FIG. 3 is a perspective view of a lead pin for a package substrate according to an embodiment of the present invention;

FIG. 4 is a side view of a lead pin for a package substrate according to an embodiment of the present invention;

FIG. 5 is a diagram showing a configuration in which a lead pin for a package substrate according to an embodiment of the present invention is bonded to a package substrate;

FIGS. 6 and 7 are graphs explaining experimental values for a lead pin for a semiconductor package according to an embodiment of the present invention;

FIG. 8 is a perspective view of a lead pin for a package substrate according to another embodiment of the present invention;

FIG. 9 is a diagram showing a configuration in which a lead pin for a package substrate according to another embodiment of the present invention is bonded to a package substrate;

FIG. 10 is a perspective view showing one modified example of the lead pin for the package substrate of FIG. 8; and

FIG. 11 is a perspective view showing a lead pin for a package substrate according to another modified example of the lead pin for the package substrate of FIG. 8.

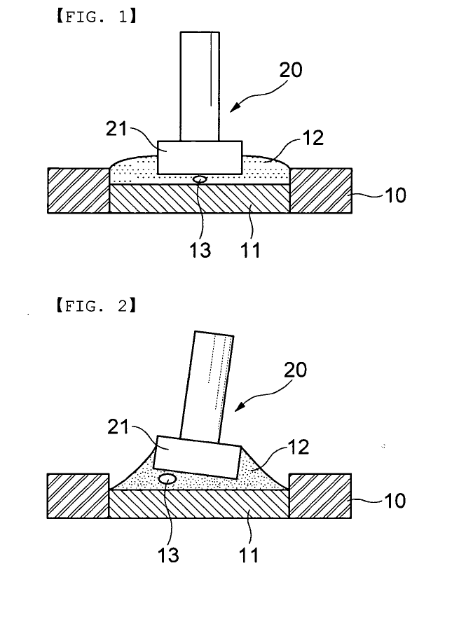

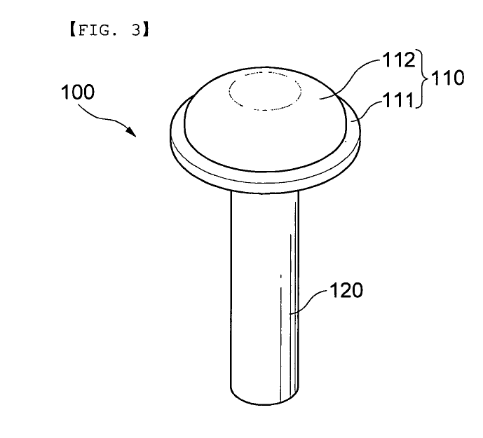

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals in the drawings denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a lead pin for a package substrate according to one embodiment of the present invention will be described in detail.

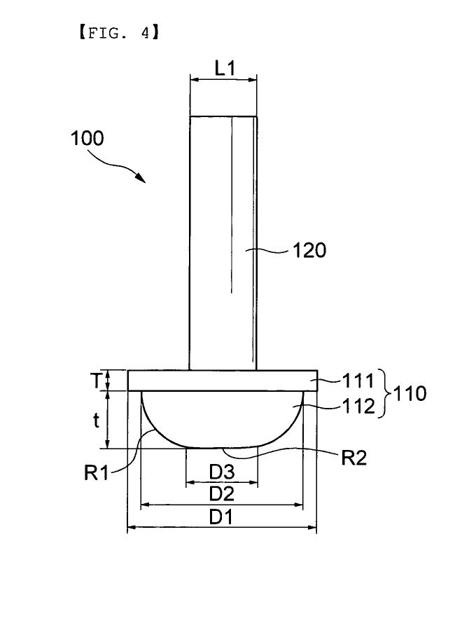

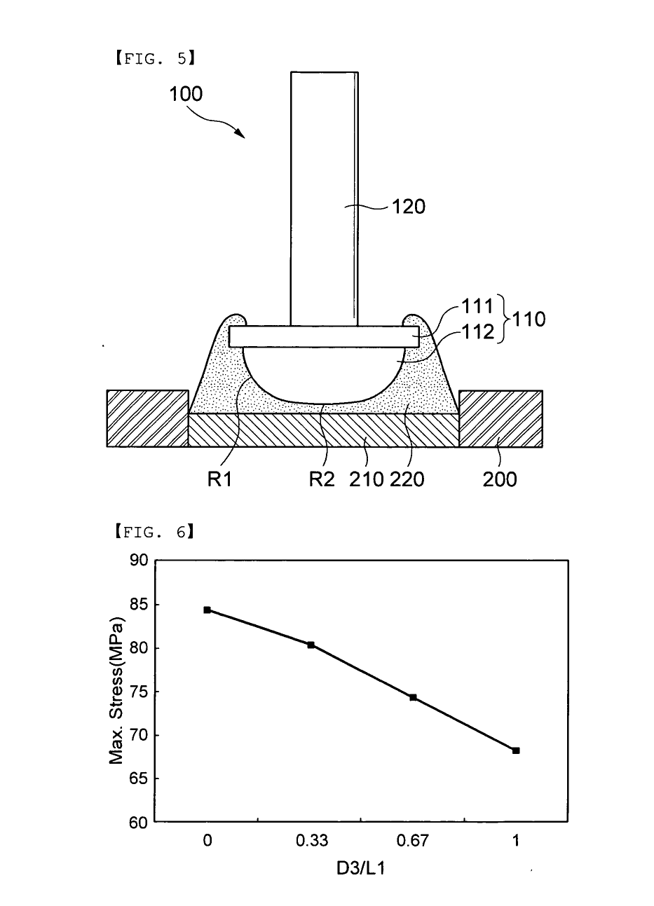

FIG. 3 is a perspective view of a lead pin for a package substrate according to an embodiment of the present invention, and FIG. 4 is a side view of a lead pin for a package substrate according to an embodiment of the present invention. FIG. 5 is a diagram showing a configuration in which a lead pin for a package substrate according to an embodiment of the present invention is bonded to a package substrate.

Referring to FIGS. 3 to 5, the lead pin 100 for the package substrate according to an embodiment of the present invention may include a head part 110 that is mounted on a pad part 210 of a package substrate 200 by interposing a solder paste 220 between the head part 110 and the pad part 210, and a connection pin 120 that is vertical to the head part 110. The connection pin 120 may be a portion that is inserted into a socket or the like when the lead pin 100 is mounted on the package substrate 200. The connection pin 120 may be formed in a cylindrical shape having a predetermined length according to the type of the package substrate 200. When the lead pin 100 is mounted, the connection pin 120 may be coupled so that it is projected to the upper portion of the package substrate 200.

The head part 110 may be formed on one end of the connection pin 120. The head part 110 may have a structure in which a substantially disk-shaped flange part 111 and a substantially hemispherical round part 112 are disposed in succession. The head part 110 may be provided so that the round part 112 is mounted on the pad part 210 of the package substrate 200 to be opposite to each other.

A diameter D1 of the flange part 111 that is formed on one end of the connection pin 120 may be larger than a diameter D2 of the hemispherical round part 112 that is projected from the bottom surface of the flange part 111. Therefore, when the head part 110 is bonded to the solder paste 220 printed on the pad part 210, the solder paste 220 is introduced into a space between the bottom surface of the flange part 111 and the outer circumferential surface of the round part 112 and the solder paste 220 surrounding the round part 112 is discharged into the top surface of the flange part 111 to prevent the solder paste 220 from bulging along the surface of the connection pin 120. In other words, the flange part 111 may function as a stopper for the bulge phenomenon of the solder paste 220.

The diameter D1 of the flange part 111 and the diameter D2 of the round part 112 may be controlled to have a diameter ratio of D1:D2, that is, approximately 1:0.50 to 1:0.98. More preferably, the diameter ratio of D1:D2 may be controlled to be substantially 1:0.70 to 1:0.80. When the diameter ratio of D1:D2 is 1:0.70 or less, a contact area of the solder paste 220 that surrounds the head part 110 and the round part 112 becomes small, such that an inclination may be generated and a bonding strength may be weakened. In contrast, when the diameter ratio of D1:D2 is 1:0.80 or more, the bilaterally projected widths of the flange part 112 become narrow, such that the function of the flange part as the stopper for the solder paste 220 may be degraded.

In addition, the height T of the flange part 111 may be different from the height t of the round part 112. For example, the height T of the flange part 111 may be thinner than the height t in the center of the round part 112. Herein, the reason why the maximum height t of the round part 112 is formed to be larger is to increase an area where the solder paste 220 surrounding the head part 110 contacts the curved surface of the round part 112, when the lead pin 100 is mounted on the package substrate 200. As a result, the connection pin 120 can be vertically installed on the package substrate 200 without being inclined and a bonding efficiency of the lead pin 100 due to the expansion of the contact area can be improved. Herein, the flange part 111 functions as a stopper in order to prevent the solder paste 220 from being discharged to the upper portion of the head part 110, such that the height T of the flange part 111 may be constituted to have a minimum height.

The flange part 111 may function as a stopper in order to prevent the solder paste 220 contacting the curved surface of the round part 112 from being discharged to the upper portion of the head part 110. Therefore, the flange part 111 may have a thickness that is thin enough to prevent the discharge path of the solder paste 220.

Meanwhile, since the round part 112 is projected from the flat bottom surface of the flange part 111 at a predetermined height, it may be preferable to improve a bonding performance of the round part 112 by maintaining the maximum contact area with the solder paste 220. For example, the round part 112 may be configured to include a first curved surface that is extended upward from the flange part 111, having a predetermined curvature, and a second curved surface that is connected to the first curved surface and is substantially flat. A radius of curvature R1 of the first curved surface may be smaller than a radius of curvature R2 of the second curved surface. For example, the second curved surface may be close to a substantially flat surface. In other words, the second curved surface of the round part 112 may also be replaced by a completely flat surface. For example, the radii of curvature R1 and R2 of the first and second curved surfaces may be the same. In this case, the outer circumferential surface of the round part 112 may have a curved surface with an entirely identical curvature.

A diameter D2 of the round part 112 and a diameter L1 of the flange part 111 may be controlled to have a diameter ratio of approximately 1:1.1 to 1:5. When the diameter ratio of the round part 112 and the flange part 111 is 1:1.1 or less, the bilaterally projected widths of the flange part 111 become small, such that the flange part functioning as the stopper for the solder paste 220 may be degraded. In contrast, when the ratio of the diameter D2 of the round part 112 and the diameter D1 of the flange part 111 is 1:5 or more, a contact area of the solder paste 220 surrounding the head part 110 and the round part 112 becomes small, such that the lead pin 100 may be inclined and a bonding strength with respect to the package substrate 200 may be weakened.

Meanwhile, the round part 112 is a portion of which a bottom surface is directly bonded to the pad part 210 of the package substrate 200 through the solder paste 220. Therefore, a bonding efficiency of the lead pin 100 may be determined depending on the shape of the round part 112. For example, as the round part 112 has the larger diameter D2 and the larger radius of curvature, the lead pin 100 can be stably mounted on the package substrate 200 without being inclined. However, when the diameter D2 and the radius of curvature of the round part 112 are excessively large, effects of removing voids in the solder paste 220 may be degraded. Therefore, the round part 112 is constituted to have variable diameter and radius of curvature, in consideration of the projected height, diameter, and the like of the connection pin 120. For example, as the diameter D2 and radius of curvature of the round part 112 are larger, the lead pin 100 can be stably mounted, however, as the diameter D2 and radius of curvature of the round part 112 are smaller, the laterally projected widths of the flange part 111 become large to enable to increase the effects of preventing the solder paste 220 from being discharged into the upper portion of the flange part 111. Therefore, the diameter of the round part 112 may be varied with respect to the diameter L1 of the connection pin 120 of which diameter is set according to standards of electronic components. Therefore, the diameter D2 of the round part 112 may substantially have a diameter ratio of 1:0.22 to 1:3.92 with respect to the diameter L1 of the connection pin 120. In other words, when the lead pin 100 is mounted on the package substrate 200, it is preferable that the lead pin 100 is designed to have an optimal diameter ratio of the round part 112 capable of securing a maximum contact area. To this end, if the connection pin 120 is determined to have a diameter L1 of 0.3 mm, it is preferable that the diameter ratio of the connection pin 120 and the round part 112 is 1:2.5.

Further, as the first and second radii of curvature R1 and R2 of the round part 112 are smaller, the voids in the solder paste 220 can be easily discharged but a bonding performance may be degraded due to reduction in the contact area between the round part 112 and the solder paste 220. Therefore, the round part 112 has a radius of curvature of 0.5 to 1 mm, which can improve the bonding performance by maintaining the maximum contact area with the solder paste 220, while discharging the voids.

Meanwhile, when the diameter ratio of D1:D2 is substantially 0.8, the ratio of the diameter D3 of the second curved surface and the diameter L1 of the connection pin 120 may meet approximately 0.3:0.7. For example, when the diameter ratio of D1:D2 is controlled to be approximately 0.8 and the second curved surface is controlled to be substantially flat, the ratio of the diameter D3 of the second curved surface and the diameter L1 of the connection pin 120 may meet 0.3 to 0.7.

The round part 112 may be a portion which directly contacts the pad part 210 of the package substrate 200 through the solder paste 220. Therefore, as the round part 112 has the larger diameter and the larger radius of curvature, the lead pin 100 can be stably mounted on the package substrate 200 without being inclined. However, as the round part 112 has the larger diameter and the larger radius of curvature, effects of removing voids in the solder paste 220 may also be degraded. Therefore, the round part 112 may be constituted to have variable diameter and radius of curvature, in consideration of the projected height, diameter, and the like of the connection pin 120.

For example, as the round part 112 has the larger diameter and the larger radius of curvature, the head part 110 can be stably mounted. In contrast, as the round part 112 has the smaller diameter and the smaller radius of curvature, the laterally projected widths of the flange part 111 become large to enable to increase the effects of preventing the solder paste 220 from being discharged into the upper portion of the flange part 111, when mounting the head part 112.

Therefore, the diameter D2 of the round part 112 may be varied with respect to the diameter L1 of the connection pin 120 of which diameter is set according to standards of electronic components. For example, the diameter D2 of the round part 112 may have a diameter ratio of 1:0.22 to 1:3.92 with respect to the diameter L1 of the connection pin 120. In other words, in the case of the lead pin 100 designed as above, the diameter ratio may be controlled so that the lead pin 100 is not inclined when the lead pin 100 is mounted on the pad part 210 of the package substrate 200 and a maximum contact area is secured. If the connection pin 120 is determined to have a diameter L1 of 0.3 mm according to the recent standards of the connection pin 120, it is most preferable that the diameter ratio of L1:D2 between the connection pin 120 and the round part 112 is approximately 1:2.5.

Further, as the radii of curvature of the round part 112 are smaller, the voids in the solder paste 220 can be easily discharged but a bonding performance may be degraded due to reduction in the contact area between the round part 112 and the solder paste 220. Therefore, the round part 112 may have a radius of curvature of 0.5 to 1 mm, which can improve the bonding performance by maintaining the maximum contact area with the solder paste 220, while discharging the voids.

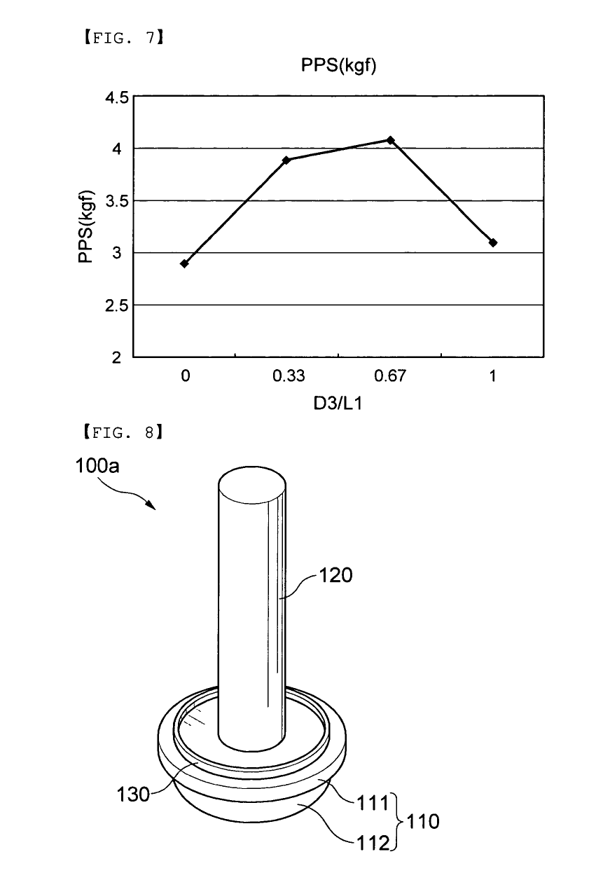

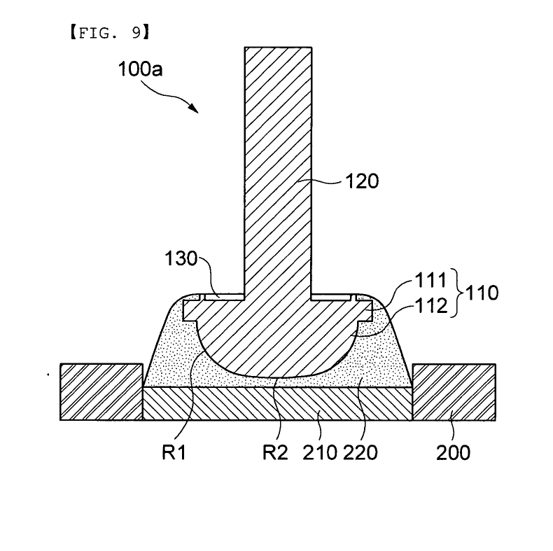

FIGS. 6 and 7 are graphs explaining experimental values for a lead pin for a semiconductor package according to an exemplary embodiment of the present invention.

Referring to FIGS. 3 to 6, in the graph of FIG. 6, a horizontal axis shows a ratio of D3/L1 of the diameter D3 of the second curved surface and the diameter L1 of the connection pin 120, and a vertical axis shows stress applied to the solder paste 220. Herein, when the diameter ratio of the flange part 120 and the round part 130 meets the values in the range of 0.7 to 0.8, a ratio of the sum T+t of a height T of the flange part 120 and a height t of the round part 130 and the diameter of the connection pin 110 may be controlled to be substantially 1:0.8333.

As shown in the graph, as the diameter D3 of the second curved surface of the round part 130 becomes larger, the stress applied to the solder paste 220 connecting the lead pin 100 is reduced, and as the diameter D3 of the second curved surface becomes smaller, the stress applied to the solder paste 220 is reduced.

However, if the diameter D3 of the second curved surface becomes larger, volume of the solder paste 200 is reduced, thereby causing a problem that adhesion of the solder paste 220 is degraded. Therefore, it may be preferable that the ratio of the diameter D3 of the second curved surface and the diameter L1 of the connection pin 120 is controlled to meet 0.3 to 0.7.

Referring to FIGS. 3 to 7, in the graph of FIG. 7, a horizontal axis shows a ratio of D3/L1 of the diameter D3 of the second curved surface and the diameter L1 of the connection pin 120, and a vertical axis shows pin pull strength (PPS) values. The PPS values represent evaluations determined by the interaction between the adhesion of the solder paste 40 and the stress applied to the solder paste 40. When the ratio of the diameter D3 of the second curved surface and the diameter L1 of the connection pin 120 is substantially smaller than 0.3, the PPS values are significantly reduced. Further, when the ratio of the diameter D3 of the second curved surface and the diameter L1 of the connection pin 120 is substantially larger than 0.7, the PPS values are significantly reduced. In other words, when the ratio of the diameter of the second curved surface and the diameter of the connection pin 120 meet substantially 0.3 to 0.7, the PPS values are significantly high as compared to other cases. Therefore, the ratio of the diameter D3 of the second curved surface and the diameter L1 of the connection pin 120 is controlled to meet substantially 0.3 to 0.7, thereby making it possible to provide a structure of the lead pin 100 to minimize the stress applied to the solder paste 220 and to improve the bonding reliability of the lead pin 100 when mounting the lead pin 100.

As described above, the lead pin 100 according to the exemplary embodiment of the present invention may be mounted, in plural, on the pad part 210 on which the solder paste 220 having a wiring pattern is printed, having an equivalent interval. Herein, the lead pin 100 may be disposed on the pad part 210 so that the head part 110 of the lead pin 100 faces downward and the connection pin 120 thereof faces upward. The solder paste 220, made of an alloy of lead, zinc, and silver, is melted in a liquid-phase form having viscosity by applying heating and is cured in a melted-state shape by a normal temperature cooling, wherein the objects to be bonded are bonded to each other in a cured state.

The solder paste 220 applied between the head part 110 and the pad part 210 is melted through an annealing process for melting the solder paste 220, that is, a reflow process, to allow the lead pin 100 to be bonded onto the package substrate 200.

When the solder paste 220 is melted during the reflow process, voids may be generated in the solder paste by abrupt melting thereof. However, the voids may be discharged laterally with respect to the head part 110 along the curved surface of the round part 112 of the head part 110. As a result, the lead pin 100 can be vertically coupled onto the package substrate 200 without being inclined.

Further, the solder paste 220 may bulge upward along the object to be bonded during the reflow process. However, the bulge phenomenon of the solder paste 220 contacting the curved surface of the round part 112 can be prevented by the flange part 111 having a larger diameter than the round part 112. For example, the flange part 111 may function as a stopper to prevent the flow path of the solder paste 220 melted between the round part 112 and the pad part 210 of the package substrate 200.

Hereinafter, a lead pin for a package substrate according to another embodiment of the present invention will be described in detail. Herein, a description overlapped with the lead pin 100 for the package substrate as described above may be omitted or simplified.

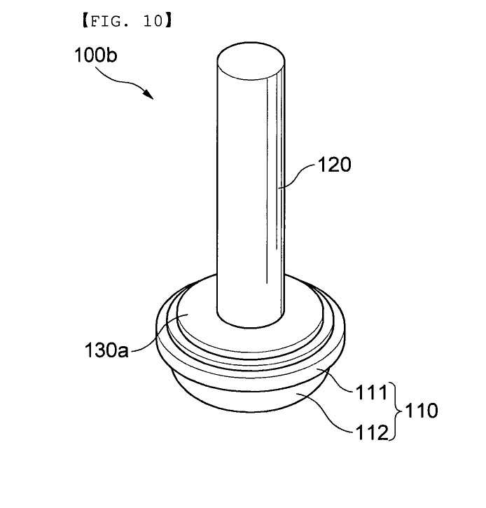

FIG. 8 is a perspective view of a lead pin for a package substrate according to another embodiment of the present invention, and FIG. 9 is a diagram showing a configuration in which a lead pin for a package substrate according to another embodiment of the present invention is bonded to a package substrate.

Referring to FIGS. 8 and 9, the lead pin 100a for the package substrate according to another embodiment of the present invention may include a connection pin 120, a head part 110 that is provided at one end of the connection pin 120, and a solder introducing preventing part 130 that is provided on the head part 110. The connection pin 120 and the head part 110 may have the same configuration as those described with reference to FIGS. 3 to 5 and thus, the detailed description thereof will be omitted.

The solder introducing preventing part 130 can prevent the solder paste 220 from being bonded to the connection pin 120 when the lead pin 100a is bonded to the pad part 210 of the package substrate 200. In addition, the solder introducing preventing part 130 may limit the introducing conditions of the solder paste 220 so that the solder paste 220 covers only up to the preset portions of the flange part 111 of the head part 110.

For example, the solder introducing preventing part 130 may have a structure that projects, as a ring shape, from the top surface of the flange part 111 based on the center of the connection pin 120. Herein, the top surface may be opposite to a surface on which the round part 112 of the flange part 111 is formed. Therefore, the surface of the flange part on which the round part 112 is formed may be a bottom surface thereof. The solder introducing preventing part 130 may be disposed on a region between the edge of the flange part 111 and the outer circumferential surface of the connection pin 120. When the solder introducing preventing part 130 is excessively close to the edge of the flange part 111, a portion of the solder paste 220 to cover the flange part 111 becomes small, such that strength of the solder paste 220 to support the connection pin 120 may be weakened. In contrast, when the solder introducing preventing part 130 is too close to the connection pin 120, it may not serve to prevent the solder paste 220 from being introduced into the connection pin 120.

Continuously, modified examples of the lead pin for the package substrate according to another embodiment of the present invention described above will be described in detail. Herein, descriptions that overlap with the lead pin 100a for the package substrate 110a described above will be omitted or simplified.

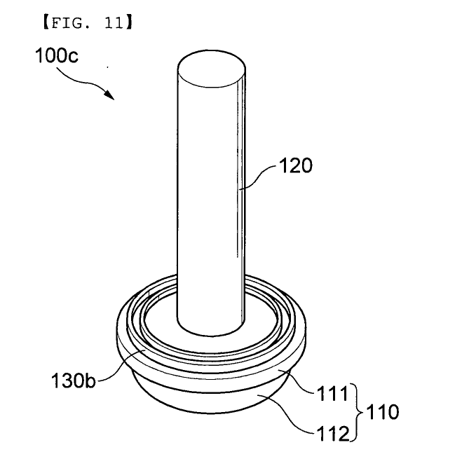

FIG. 10 is a perspective view showing one modified example of the lead pin for the package substrate of FIG. 8. Referring to FIG. 10, a lead pin 100b for the package substrate may include a solder introducing preventing part 130a having a step shape in which the height becomes higher as the solder introducing preventing part 130a becomes closer to the connection pin 120, as compared to the lead pin 100a for the package substrate described with reference to FIG. 8. The solder introducing preventing part 130a having the structure described above can prevent the solder paste from being introduced into the connection pin 120 via two steps.

FIG. 11 is a perspective view showing a lead pin for a package substrate according to another modified example of the lead pin for the package substrate of FIG. 8. Referring to FIG. 11, a lead pin 100c for the package substrate may include a solder introducing preventing part 130b including ring shaped preventing bodies that surround the connection pin 120 and has different diameters, as compared to the lead pin 100a for the package substrate described with reference to FIG. 8. In this case, the solder introducing preventing part 130b may have an annular ring structure. Among the rings, an outermost ring can serve to limit the function of the solder paste to cover the portion of the flange part 111. The solder introducing preventing part 130a having the structure described above can prevent the solder paste from being introduced into the connection pin 120 via two steps.

According to the present invention, when the lead pin for the package substrate is mounted on the package substrate, the bulge phenomenon that the solder paste that surrounds the head part and is melted is prevented by the flange part, thereby making it possible to prevent the connection pin from being polluted and improve a contact defect such as a short or the like when coupling a socket.

The lead pin for the package substrate according to the present invention can allow the voids generated within the solder paste melted between the head part and the package substrate to be easily discharged laterally along the curvature of the round part and further allow the solder paste to be in contact along the curved surface of the round part. Therefore, the lead pin for the package substrate according to the present invention increases the contact area for the package substrate, thereby making it possible to improve the bonding reliability of the lead pin.

The lead pin for the package substrate according to the present invention can include the solder introducing preventing part that prevents the solder paste surrounding the head part and being melted from being introduced into the connection pin, when the lead pin for the package substrate is bonded. Therefore, the lead pin for the package substrate according to the present invention prevents the solder paste from being bonded to the connection pin, thereby making it possible to prevent the connection pin from being polluted and to prevent a contact defect such as an electrical short or the like when coupling a socket.

The present invention has been described in connection with what is presently considered to be practical exemplary embodiments. Although the exemplary embodiments of the present invention have been described, the present invention may be also be used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A lead pin for a package substrate that is bonded to a package substrate by interposing a solder paste between the lead pin for the package substrate and the package substrate, the lead pin for the package substrate comprising:
a cylindrical connection pin; and
a head part that is formed on one end of the connection pin,
wherein the head part includes a disk shaped flange part; and a round part that is formed on one surface of the flange part and is configured to include first and second curved surfaces having different radii of curvature, the first and second curved surfaces each having different radii of curvature selected from a range of 1:0.1 to 1:5 as compared to a diameter of the connection pin.

2. The lead pin for the package substrate according to claim 1, wherein the connection pin is projected from one surface of the flange part and the round part is projected from the other surface of the flange part so as to have a diameter larger than that of the connection pin.

3. The lead pin for the package substrate according to claim 2, wherein the round part has a diameter ratio of 1:0.5 to 1:0.98 with respect to a diameter of the flange part.

4. The lead pin for the package substrate according to claim 1, wherein the round part has a height higher than that of the flange part.

5. The lead pin for the package substrate according to claim 1, wherein the flange part has a diameter ratio of 1:1.1 to 1:5 with respect to the diameter of the connection pin, and the round part has a diameter ratio of 1:0.22 to 1:3.92 with respect to the diameter of the connection pin.

6. The lead pin for the package substrate according to claim 1, wherein during a process of mounting the lead pin on the package substrate using the solder paste, the round part allows voids within the solder paste to be discharged laterally along the round part.

7. The lead pin for the package substrate according to claim 1, wherein the first curved surface is extended from the flange part, the second curved surface is connected to an end of the first curved surface and has a curvature smaller than that of the first curved surface, and the ratio of the diameter of the second curved surface and the diameter of the connection pin is 0.3 to 0.7.

8. A lead pin for a package substrate that is bonded to a package substrate by interposing a solder paste between the lead pin for the package substrate and the package substrate, the lead pin for the package substrate comprising:
a cylindrical connection pin; and
a head part that is formed on one end of the connection pin,
wherein the head part includes a disk shaped flange part having a larger diameter than the connection pin; a round part that is formed on a bottom surface of the flange part and is projected from the bottom surface to be bulged; and a solder introducing preventing part that is projected from a top surface of the flange part that is opposite to the bottom surface and prevents the solder paste from being introduced into the connection pin.

9. The lead pin for the package substrate according to claim 8, wherein the solder introducing preventing part is disposed on a region between the outer circumferential surface of the connection pin and the edge of the flange part.

10. The lead pin for the package substrate according to claim 8, wherein the solder introducing preventing part has a ring shape to surround the connection pin.

11. The lead pin for the package substrate according to claim 10, wherein the solder introducing preventing part has an annular ring structure by allowing ring shaped preventing bodies having different diameters to surround the connection pin.

12. The lead pin for the package substrate according to claim 8, wherein the solder introducing preventing part has a step shape in which the height becomes higher as the solder introducing preventing part becomes closer to the connection pin.

13. The lead pin for the package substrate according to claim 8, wherein the solder introducing preventing part limits the size of the portion of the solder paste to cover the flange part.

14. The lead pin for the package substrate according to claim 8, wherein a diameter ratio of the connection pin and the flange part is 1:1.1 to 1:5.

15. The lead pin for the package substrate according to claim 8, wherein the round part has different radii of curvature at the center of the round part and the edge of the round part, the diameter of the connection pin and a first radius of curvature at the center of the round part having a diameter ratio of 1:0.1 to 1:5, and the diameter of the connection pin and a second radius of curvature at the edge of the round part having a diameter ratio of 1:0.1 to 1:5.

16. The lead pin for the package substrate according to claim 15, wherein the first radius of curvature and the second radius of curvature have the same size.

17. The lead pin for the package substrate according to claim 8, wherein the maximum height of the round part is higher than the height of the flange part.
